(19) United States
(12) Patent Application Publication
(10) Pub. No.: US 2012/0190430 A1
(43) Pub. Date: Jul. 26, 2012

(54) Ball Distributing Mechanism For Games

(76) Inventor: Miguel Puyol, Sao Paulo (BR)

(21) Appl. No.: 13/383,623

(22) PCT Filed: Jul. 13, 2010
(86) PCT No.: PCT/BR10/00235

§ 371 Date: Mar. 29, 2012

(30) Foreign Application Priority Data
Jul. 16, 2009 (BR) PI0902444-1

(51) Int. Cl. A63F 13/08; A63F 13/12

(52) U.S. Cl. 463/22; 463/16

(57) ABSTRACT

This request for Patent of Invention refers to a mechanism to distribute balls, each one with individual identification, to replace playing cards, aiming at performing card game in an automated way, such as blackjack (also known in Brazil as “21”) or Poker, or any other game, so as to simulate the presence of a croupier in these games in a gambling house, such as a casino.

This patent has the purpose of providing equipment that simulates the physical distribution of cards by using balls exhibiting on their external surfaces suit and number or figure of the corresponding playing card.

Another purpose of the new mechanism is providing security means to make the ball capture for the game into a closed loop, which prevents undue ball removal or insertion.

Another purpose is showing physically the distribution of cards for each individual player by using a moving arm that is positioned in front of each player and that releases the balls previously shuffled and captured by a random system.

Another purpose is reducing costs, by eliminating the croupier function.

Another purpose is providing a playing mechanism where the player is capable of viewing the balls being moved and distributed, by accessing only the balls distributed to each player.

Another purpose is providing means to send information on the balls distributed to a computer system, which enables each player to follow the game development on display screens

This request for Patent of Invention refers to a mechanism to distribute balls, each one with individual identification, to replace playing cards, aiming at performing card game, such as blackjack (also known in Brazil as “21”) or Poker, or any other game, so as to simulate the presence of a croupier in these games in a gambling house, such as a casino.

In general, a casino or gambling house has in card playing tables an employee known as croupier, who coordinates the game, distributes the cards and acts on behalf of the “establishment” in the game, being responsible for its actions in the result of each game.

The croupier actions may raise suspicion on his/her honesty both for the gambling house and the players, and several cases of fraud were reported, with the purpose of achieving better financial result for the gambling house or for a given player.

By the other side, the croupier represents a high cost for the gambling house, due to his/her salary and all the resulting expenses, including job turnover.

Computerized card games have been developed and used in gambling houses to eliminate the croupier function, where a display typically exhibits the games being conducted based on players' actions. However, such games are not fully trustful for the players, as the machine program may be coded to favor the gambling house, since there is no physical distribution of cards.

This patent has the purpose of providing equipment that simulates the physical distribution of playing cards by using balls that exhibit the card suit and number/figure.

Another purpose of the new mechanism is providing security means to make the ball capture for the game into a closed loop, without any manual intervention, which prevents undue ball removal or insertion.

Another purpose is showing physically the distribution of cards for each individual player by using a moving arm that is positioned in front of each player and that releases the balls previously shuffled and captured by a random system.

Another purpose is reducing costs, by eliminating the croupier function.

Another purpose is providing a playing mechanism where the player is capable of viewing the balls being moved and distributed, by accessing only the balls distributed to each player.

Another purpose is providing means to send information on the balls distributed to a computer system, which enables each player to follow the game development on display screens, thus making them able to take decisions for the game progress.

For better clarification purposes, the drawings that illustrate the process are attached herein, as follows:

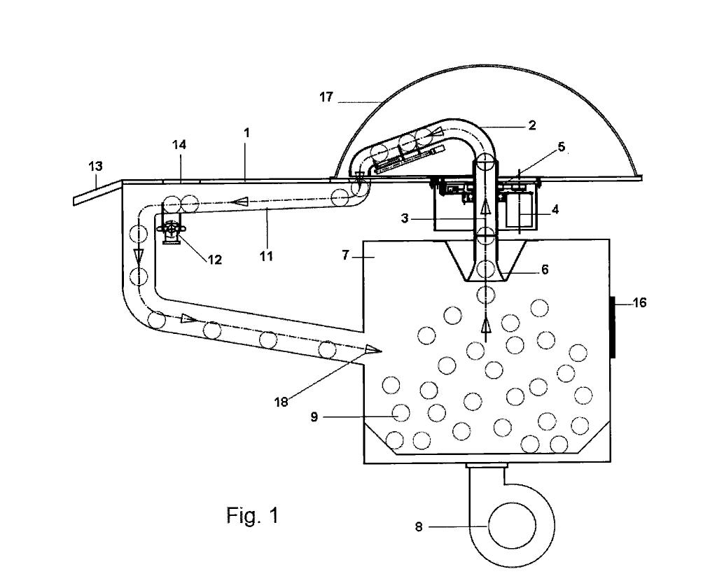

FIG. 1: Schematic cross-section view of a ball distribution equipment for games.

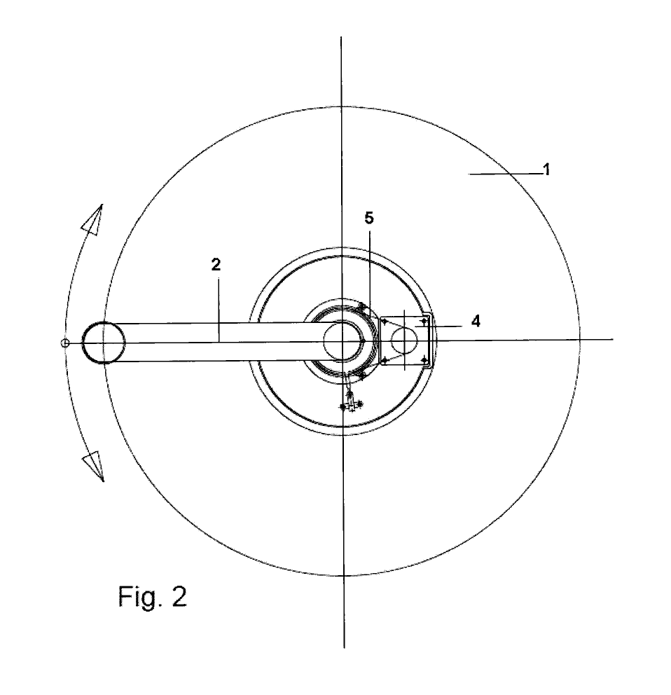

FIG. 2: Plan view of the ball distribution equipment for games.

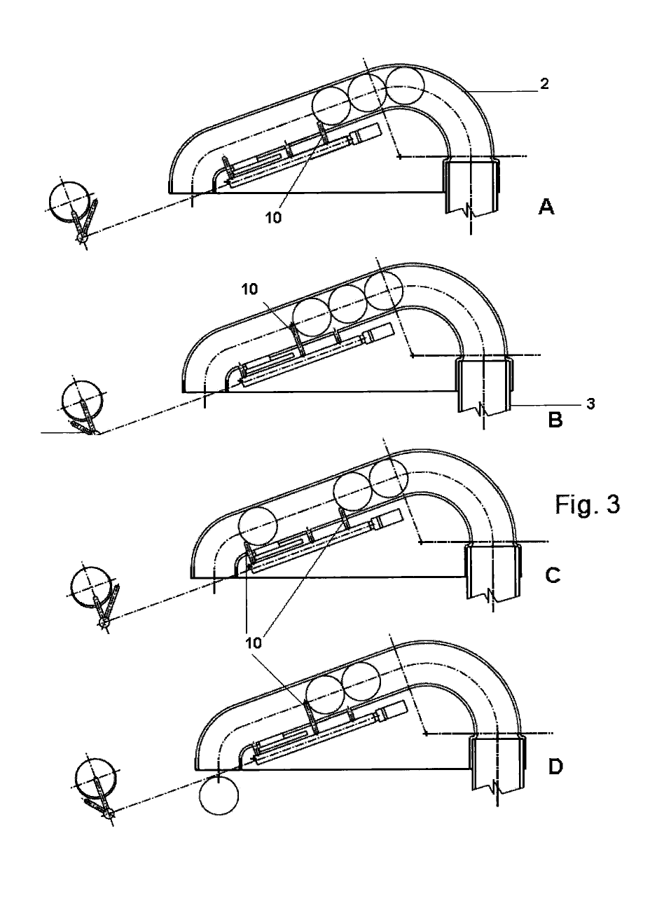

FIG. 3: Schematic view of the ball positions in four stages, “A”, “B”, “C” and “D”, within the distribution arm.

According to the attached illustrations, the game mechanism is typically comprised by one table (1) provided in the central region by a rotating tubular arm (2) assembled on a tubular shaft (3) moved by a step motor (4), which is connected by a belt (5), and the tubular shaft (3) has an inverted funnel-like entrance (6) arranged on a chamber (7) where the balls are maintained in ongoing agitation by an air stream proceeding from a fan or turbine (8).

The balls (9), with even and suitable weight, remain in continuous motion by the airflow from the lower turbine (8) so as to draw the balls (9), by suction resulting from the airflow to be directed towards the shaft (3), to inside the tubular shaft (3) and inward the moving arm (2).

The moving arm (2) has format sloped downwards from the shaft (3) in order to create descending ramp where the balls are maintained in position by bars or barriers (10), which are driven by mechanisms, such as servomotor, to retain or release the balls (9).

Once the ball (9) is released, it slides on a ramp (11) to a retention system by servo-assisted bar (12), and after being released, the ball falls inside a duct (13) and returns to the chamber (7).

The ball (9) has an internal RFI tag or sensor so as to identify it, that is, to enable reading the suit and number or figure corresponding to the ball via radio signal, and including RFI reading sensors in the retention region (10) of the moving arm (2), which send the information about the ball present in that position to a computer, and distributing this information, as soon as the ball is released, to the display (13) of the corresponding player, and to the displays of other players if this card is open. The information may also be displayed on a wide screen visible by the public in general.

The corresponding player may view the ball with suit and number or figure on a screen (14) installed on the table (1) within his/her action area, thus assuring that the ball distributed to him/her corresponds to the card exhibited on the display (13).

The arm (2) moves in such a way to follow the position order of each individual player to distribute the balls, including the “croupier” position. The referred arm (2) is opaque, thus preventing the players from viewing the balls inside it.

The moving arm positioning is made by a step motor (4), which is commanded by the computer that controls the entire system and game.

The position corresponding to the croupier may include a cover (15) on the corresponding display (14), when the game includes closed cards distributed to him/her.

This cover (15) is also driven by a servo-mechanism in an automated way, according to the game progress, so as to hide or enable viewing the cards previously distributed to the croupier's position.

Due to its design, the ball distribution mechanism enables the players to view the entire process for ball selection and distribution to the players in a physical way, so as to assure the game honesty, while preventing the gambling house from being defrauded by anyone, as this is an automated process, in addition to reducing operating costs.

For security purposes, the chamber (7) and the entire loop where the balls circulate are sealed, except for one door (16) provisioned in the chamber (7) for maintenance purposes and to replace defective balls. Such door (16) is equipped with sensors (not shown), which indicate its opening, and in this case, the equipment is capable of checking whether all the balls are within the equipment by reading their RFI sensors via radio frequency reading system.

Finally, a clear dome (17) may be placed on the table, enclosing the region where the moving arm (2) operates, aiming at protecting it.

The RFI sensors are not shown and this patent scope does not cover their constructive design, as well as the servo-mechanisms, door sensor or fan type or model, since these are elements already known and applied to enable the equipment operation.

As the purpose of the request for patent is providing a mean to simulate the distribution of cards by corresponding balls via a moving arm, this patent document shows a preferred construction, but that covers any construction that may be considered as an obvious variation from the design provided herein.

1) “BALL DISTRIBUTION MECHANISM FOR GAMES”, comprised by:
One moving tubular arm (2).
Balls with RFI tag.
One tubular shaft (3) driven by step motor (4).
One chamber (7).
Ramps (11) for ball direction control (9).
Displays (14).
Table (1) with screens (14).
Computer.

2) The “BALL DISTRIBUTION MECHANISM FOR GAMES”, according to claim 1, is characterized by the fact that the moving arm (2) forms a descending ramp from the center of rotation arranged on the shaft (3), and the descending section of the arm (2) is equipped with bars (10) driven by servo-mechanism and provided with RFI reading sensor via radio frequency.

3) The “BALL DISTRIBUTION MECHANISM FOR GAMES”, according to claim 1, is characterized by the fact of being delivered with balls (9) equipped with internal RFI tags, which are read via radio frequency, and exhibiting on their external surface suits and number or figures corresponding to one or more playing card decks.

4) The “BALL DISTRIBUTION MECHANISM FOR GAMES”, according to claim 1, is characterized by the fact that the shaft (3) turns by a belt (5) driven by step motor (4).

5) The “BALL DISTRIBUTION MECHANISM FOR GAMES”, according to claim 1, is characterized by the fact that the chamber (7) has one turbine or fan (8), one door (16) for external access, one top inverted funnel-like shape opening (6) coupled to the tubular shaft (3), and one opening (18) so as to return the balls (9) inward it.

6) The “BALL DISTRIBUTION MECHANISM FOR GAMES”, according to claim 1, is characterized by the fact that ramps (11), in a quantity corresponding to the maximum number of players, irradiate from the action range of the moving arm (2) exit, which are equipped by ball (9) retention means (12) driven by servo-mechanism.
the shaft (3) turns by a belt (5) driven by step motor (4).

7) The “BALL DISTRIBUTION MECHANISM FOR GAMES”, according to claim 1, is characterized by the fact that displays (13) exhibit the game in progress and provide buttons to be pressed by the players.

8) The “BALL DISTRIBUTION MECHANISM FOR GAMES”, according to claim 1, is characterized by the fact that that one table (1) covers the entire device, and is clear in some regions, where part of the chamber (7) is visible, and by clear openings (14) where the balls are visible for each individual player. The table (1) is partially covered by a dome (17) in the moving arm (2) operation area.

9) The “BALL DISTRIBUTION MECHANISM FOR GAMES”, according to claim 1, is characterized by the fact that that one computer concentrates the information received from the RFI tags of the selected balls, controls the servo-mechanisms and arm (2) motion and the entire game and betting process.
